(19) United States
(12) Patent Application Publication
(10) Pub. No.: US 2008/0146228 A1
(43) Pub. Date: Jun. 19, 2008

(54) Mobile Communication System and Method for Packet Hand-Over Between Asynchronous Communication Network and Synchronous Communication Network, and Mobile Communication Terminal Therefor

(76) Inventors: Young-Lak Kim, Gyeonggi-do (KR); Sung-Ho Shin, Seoul (KR); Jong-Tae Ihm, Gyeonggi-do (KR)

Correspondence Address: LOWE HAUPTMAN HAM & BERNER, LLP, 1700 DIAGONAL ROAD, SUITE 300, ALEXANDRIA, VA, 22314, US

(21) Appl. No.: 11/587,165

(22) PCT Filed: Apr. 22, 2005
(86) PCT No.: PCT/KR2005/001176

§ 371 Date: Sep. 5, 2007

(30) Foreign Application Priority Data
Apr. 22, 2004 (KR) 10-2004-0027701

(51) Int. Cl. H04B 7/26; H04Q 7/20

(52) U.S. Cl. 455/436

(57) ABSTRACT

Disclosed is a mobile communication system and method for packet hand-over between asynchronous communication network and synchronous communication network, and mobile communication terminal therefor for enabling a mobile phone to be connected with a synchronous network using a call re-sending message transmitted in an asynchronous network. The mobile communication system and method saves the time that a mobile phone, which performs a packet hand-over from an asynchronous network to a synchronous network, re-connects the synchronous network with a packet call, because the call re-sending message transmitted in an asynchronous network is provided to a multi mode multi band mobile phone in case that a hand-over is requested.

### TECHNICAL FIELD

The present invention relates to a mobile communication system and method for packet hand-over between asynchronous communication network and synchronous communication network, and mobile communication terminal therefor, and more particularly to a mobile communication system and method for packet hand-over between asynchronous communication network and synchronous communication network, and mobile communication terminal therefor for enabling a mobile phone to be connected to a synchronous communication network using a call re-sending message transmitted in an asynchronous network such that a packet hand-over between asynchronous communication network and synchronous communication network can be performed.

### BACKGROUND ART

A variety of mobile communication systems have been proposed concomitant with development of mobile communication technologies and evolution of communication networks, and as a result, an IMT-2000 system has been developed for solving global roaming problems between mobile communication systems. The IMT-2000 system is divided into a CDMA (Code Division Multiple Access) 2000-based synchronizing method system and a WCDMA-based asynchronizing method system.

Furthermore, a mobile mode multiband useable both in the synchronizing method system and asynchronizing method system for assisting the global roaming between the mobile communication systems has been also developed. By way of the mobile communication terminals thus explained, respectively different methods of services can be utilized in the asynchronous method system section and in the synchronous method system section.

Currently, the asynchronous mobile communication system is being built about an area where there is a large service demand, such that the mobile communication system of synchronous method is evolved in service area thereof to a form including a service area of asynchronous method system, and in the process thereof, a packet hand-over is needed between the systems for providing a continuous service when a user moves between the asynchronous mobile communication system and the synchronous mobile communication system.

FIG. 1 is a flow chart for illustrating a packet hand-over method from an asynchronous mobile communication system to a synchronous mobile communication system according to the prior art.

When a mobile communication terminal of multi-mode multi-band is moved to a hand-over area while a packet call connection is made between asynchronous mobile communication system and an asynchronous modem unit of the multi mode multi band mobile communication terminal, synchronization between the mobile communication terminal and a node B is cancelled, and the node B waits until the synchronization with the mobile communication terminal is recovered (S10). At this time, a waiting time of the node B is approximately 10 seconds.

Thereafter, a pilot signal transmitted and received between the asynchronous mobile communication system and the asynchronous modem unit is weakened in the intensity thereof, resulting in a termination of the call (S30).

Successively, the synchronous modem unit of the mobile communication terminal is changed to an idle mode in response to the request of the asynchronous modem unit whose call is terminated from the node B of the asynchronous mobile communication system, and receives a pilot channel of the synchronous mobile communication system to recover the synchronization (S50). It usually takes approximately 1.25 seconds to recover the synchronization between the synchronous modem unit and the synchronous mobile communication system.

Thereafter, the synchronous modem unit re-sends the packet call to the synchronous mobile communication system (S70), and a packet call connection is established between the mobile communication terminal and the mobile communication system for which it takes approximately 6 seconds.

### DISCLOSURE OF INVENTION

### Technical Problem

As mentioned above, when the multi-mode multi-band mobile communication terminal moves to a hand-over border in the asynchronous mobile communication system section during packet call connection, a call connection between the asynchronous mobile communication system and mobile communication terminal is disconnected such that the mobile communication terminal should re-connect the packet call with the synchronous mobile communication system. At this time, as the packet call connection time is lengthened between the mobile communication terminal and the synchronous mobile communication system, waiting time of a mobile communication terminal user is also lengthened to cause an inconvenience to the user.

### Technical Solution

The present invention is disclosed to solve the afore-mentioned problems, and it is a technical object of the present invention to provide a mobile communication system and method for packet hand-over between asynchronous communication network and synchronous communication network, and mobile communication terminal therefor, wherein when a mobile communication terminal connected to a asynchronous network via call moves to a hand-over section to weaken the strength of a pilot signal, the asynchronous network transmits a call re-sending message to a mobile communication terminal, enabling a mobile phone to be connected to a synchronous network, such that a packet hand-over between the asynchronous network and a synchronous network can be made possible.

In accordance with a first aspect of the present invention, there is provided a mobile communication terminal which is a multi-mode multi-band mobile communication terminal selectively connected to asynchronous mobile communication system and a synchronous mobile communication system for performing a packet hand-over between asynchronous mobile communication system and the synchronous mobile communication system, wherein the mobile communication terminal comprises: an asynchronous modem unit receiving a call re-sending message transmitted from the asynchronous mobile communication system when a packet data service of the asynchronous mobile communication system is used; and a synchronous modem unit changing to an idle state in response to the call re-sending message transmitted from the asynchronous modem unit, and attempting a packet call re-sending with the synchronous mobile communication system in response to synchronous communication system information contained in the call re-sending message.

In accordance with a second aspect of the present invention, there is provided a mobile communication system performing a communication with a multi-mode multi-band mobile communication terminal equipped with an asynchronous modem unit and a synchronous modem unit and assisting a packet hand-over between an asynchronous mobile communication system and a synchronous mobile communication system, wherein the asynchronous mobile communication system generates a call re-sending message based on pilot signal intensity information transmitted from the mobile communication terminal and transmits the message to the mobile communication terminal when a call re-sending request condition is met during connection with the mobile communication terminal and transmission and reception of packet data.

In accordance with a third aspect of the present invention, there is provided a mobile communication method for packet hand-over between asynchronous communication network and synchronous communication network, the method comprising the steps of: an synchronous mobile communication system providing packet service to a multi-mode multi-band mobile communication terminal; receiving a pilot signal intensity information transmitted from the mobile communication terminal when a radio communication environment between the asynchronous mobile communication system and the mobile communication terminal meets a call re-sending request condition; and transmitting to the mobile communication terminal the call re-sending message thus generated to prompt the mobile communication terminal to be connected to the synchronous communication system.

### ADVANTAGEOUS EFFECTS

There is an advantage in the mobile communication system and method for packet hand-over between asynchronous communication network and synchronous communication network, and mobile communication terminal therefor thus explained according to the present invention in that a call re-sending message generated by an asynchronous network during hand-over request is provided to a multi-mode multi-band mobile communication terminal to prompt the mobile communication terminal for performing the packet hand-over from asynchronous network to synchronous network to shorten a time of re-connecting a packet call with synchronous network.

### BRIEF DESCRIPTION OF THE DRAWINGS

The above and other objects as well as advantages of the present invention will become clear by the following description of the preferred embodiments of the present invention with reference to the accompanying drawings, wherein:

FIG. 1 is a flow chart explaining a packet hand-over method from an asynchronous mobile communication system to a synchronous mobile communication system according to the prior art;

FIG. 2 is a block diagram of a mobile communication network according to the present invention;

FIG. 3 is a structural diagram of a mobile communication terminal according to the present invention; and

FIG. 4 is a flow chart explaining a packet hand-over method from an asynchronous mobile communication system to a synchronous mobile communication system.

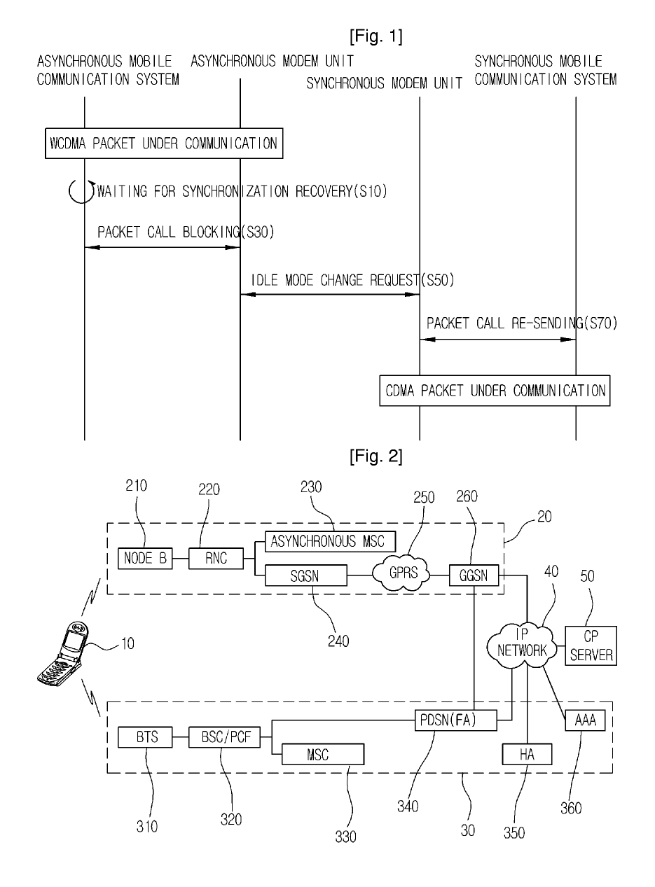

### BEST MODE FOR CARRYING OUT THE INVENTION

Preferred embodiments of the present invention will now be described in detail with reference with the annexed drawings.

In the below-mentioned description, a mobile communication terminal defines a multi-mode multi-band mobile communication terminal usable in both the asynchronous mobile communication system and the synchronous mobile communication system. The mobile communication terminal may be classified into two forms: one form which can receive a synchronous mobile communication system signal using a synchronous modem unit during service use of an asynchronous mobile communication system, and the other form which can transmit a signal to and receive a signal from a synchronous mobile communication system using a synchronous modem unit during service use of an asynchronous mobile communication system, the detail of which will be described later.

FIG. 2 is a structural diagram of a mobile communication network according to the present invention primarily centering on structural elements for providing a packet data service.

A multi-mode multi-band mobile communication terminal (10) is capable of simultaneously providing an asynchronous mobile communication service and a synchronous mobile communication service, and can selectively connect wirelessly to an asynchronous communication system (20) and a synchronous communication system (30) to use voice and data services.

The asynchronous mobile communication system (20) includes a node B (210) as a base station for radio section communication with the mobile communication terminal (10), a radio network controller (RNC, 220) for controlling the node B, an asynchronous switch board (asynchronous MSC. 230) connected to the radio network controller (220) and performing a call exchange for providing voice service via the mobile communication terminal (10), a Serving GPRS Support Node (240) connected between a radio network controller (220) and a General Packet Radio Service (GPRS) network (250) for maintaining a position track of the mobile communication terminal (10) and performing an access control and a security function, and a Gateway GPRS Support Node (GGSN. 260) connected via the SGSN (240) and the GPRS network (250) and accessed to an Internet Protocol (IP) network (40) to assist a cooperation with an external packet.

Furthermore, the synchronous mobile communication system (30) includes a base station (310) for supporting a radio section communication with the mobile communication terminal (10), a Packet Control Function (PCF. 320) for functioning in the similar way as that of a base station controller (BSC) for controlling the base station (310) and a base station controller (BSC) for radio resources control for packet data service during supply of packet data service, a switch board (MSC. 330) for performing a call exchange by being connected to a controller of one or more base stations, a packet data service node (PDSN. 340) for being connected to the packet controller (320) to establish a Point-to-Point Protocol (PPP) section with the mobile communication terminal (10) and for implementing a connection with an external node and for functioning as an foreign agent (FA) for position registration of the mobile communication terminal (10) and for providing a packet data service to subscribers, a data core network (DCN. not shown) for supporting a connection between the packet data service node (340) and IP network (40), a home agent (350) for implementing an authentication of the mobile communication terminal (10) and for transmitting packet data to the FA, and an AAA (360) for implementing authentication, authorization and account of the mobile communication terminal

Although not shown in the drawings, switch boards (230. 330) of the asynchronous mobile communication system (20) and the synchronous communication system (30) are interconnected via No. 7 common signal network to implement the transmission and reception of information necessary for hand-over of the mobile communication terminal (10).

In the mobile communication systems thus described, the mobile communication terminal (10) according to the present invention is selectively connected to the asynchronous mobile communication system (20) and the synchronous mobile communication system (30), and transmits and processes the signal process status of the two systems.

Furthermore, the asynchronous mobile communication system (20) is connected via a call with the multi-mode multi-band mobile communication terminal (10), and when the mobile communication terminal (10) is moved to a hand-over area during transmission and reception of a pilot signal to weaken a pilot signal, a pilot signal intensity information relative to a neighboring base station is received from the mobile communication terminal (10) to generate a service redirection message including a subject base station information to which the hand-over is attempted and transmits the information to the mobile communication terminal (10).

A call re-sending message includes a frequency information required for a synchronous modem unit to re-send a packet call to the synchronous mobile communication system (30), and PN code information for hand-over. The frequency information, which is frequency allocation (FA) information, defines a frequency band of 1.25 MHz. The information is also the one required for the mobile communication terminal (10) to initially obtain network information. The information also notifies which frequency band is to be searched by the mobile communication terminal (10) during hand-over.

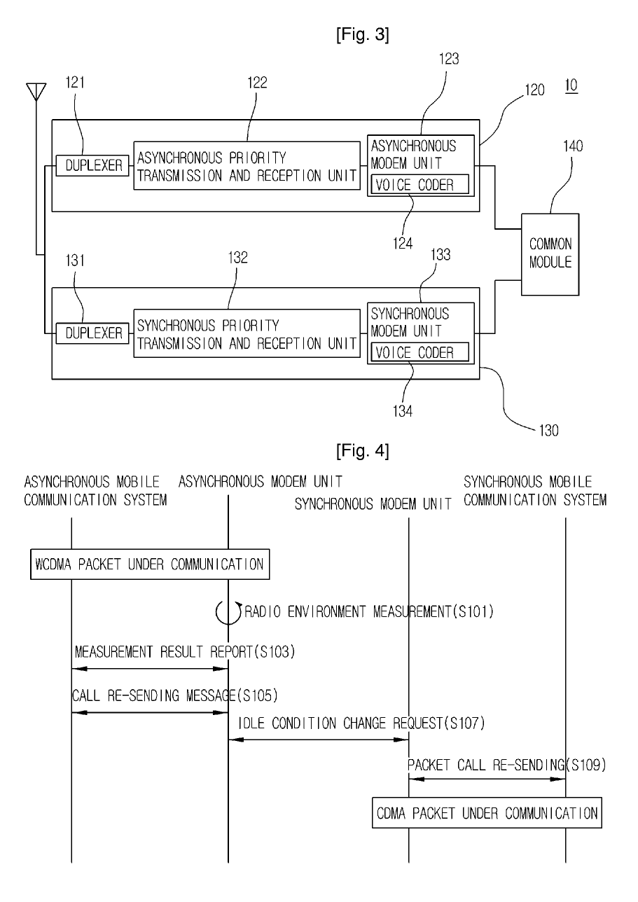

FIG. 3 is a schematic drawing for showing a structure of a mobile communication terminal according to the present invention.

The multi-mode multi-band mobile communication terminal (10) according to the present invention includes an antenna (110), a module (120) for asynchronous mobile communication service, a module (130) for synchronous mobile communication service, and a common module (140).

The antenna (110) is capable of simultaneously processing a frequency band for synchronous communication service and a frequency band for asynchronous communication service.

The asynchronous module (120) includes a duplexer (121) for operating as a band pass filter for classifying and processing each frequency, an asynchronous radio transceiver (122) for separating transmitted and received radio waves into designated frequency bands, an asynchronous modem unit (123) for processing a radio section protocol with the asynchronous mobile communication system, and a voice coder for implementing coding and decoding of voice signals.

The synchronous module (130) includes a duplexer (131) operating as a band pass filter for classifying and processing each frequency, a synchronous radio transceiver (132) for separating the transmitted and received radio waves into designated frequency band, a synchronous modem unit (133) for processing radio section protocol with the synchronous mobile communication system, and a voice coder (134) for implementing coding and decoding of voice signals.

The common module (140) includes an application processor for operating as a central processing unit for controlling the asynchronous modem unit (123) and the synchronous modem unit (133) and implementing a multi media function, a memory, an input/output unit and an application processor.

Furthermore, the multi-mode multi-band mobile communication terminal (10) is disposed with a software for processing interface, additional service, mobile administration, access/session control, resource control and protocol, such that a user is enabled to use various application services and to allow conducting a hand-over and protocol transformation fit to the mobile communication systems.

The multi-mode multi-band mobile communication terminal (10) measures a pilot signal intensity relative to a neighboring base station and sends the intensity to the asynchronous mobile communication system (20) when moved to a hand-over area during a packet call connection with the asynchronous mobile communication system (20), and receives a call re-sending message transmitted from the asynchronous mobile communication system (20).

Successively, the asynchronous modem unit (123) of the mobile communication terminal (10) transmits the call re-sending message received from the asynchronous mobile communication system (20) to the synchronous modem unit (133), such that the message can be used during connection with the synchronous mobile communication system (30).

The mobile communication terminal thus described is classified into two terminals: one is a terminal for receiving signals of the synchronous mobile communication system during use of service with the asynchronous mobile communication system, and the other is a terminal for transmitting a signal to and receiving a signal from the synchronous mobile communication system during use of service with the asynchronous mobile communication system.

When a mobile communication terminal which is capable of transmitting and receiving signals with the synchronous mobile communication system during use of service with the asynchronous mobile communication system is designed, a complicated element construction including that of the duplexes (121. 131) compared with a mobile communication terminal capable of only signal reception, and intervention of signals should be taken into consideration.

FIG. 4 is a flow chart for illustrating a packet hand-over from an asynchronous mobile communication system to a synchronous mobile communication system according to the present invention.

When a packet call is connected between the asynchronous mobile communication system (20) and the synchronous mobile communication system (10), the asynchronous modem unit (123) of the multi-mode multi-band mobile communication terminal (10) periodically measures radio environments within the mobile communication network and reports same to the asynchronous mobile communication system (20). When the mobile communication terminal (10) is moved to a border area of hand-over area to allow the intensity of the pilot signal transmitted to and received from the asynchronous communication system (20) to be lower than a first pre-determined set-up value, the asynchronous modem unit (123) measures an intensity of the pilot signal relative to a neighboring base station and transmits the intensity to the asynchronous mobile communication system (20), (S101, S103).

When the asynchronous mobile communication system (20) receives the intensity of the pilot signal from the asynchronous modem unit (123) of the mobile communication terminal (10), the asynchronous mobile communication system (20) transmits to the asynchronous modem unit (123) a call-resending message including the hand-over information of the base station in response to the received intensity of the pilot signal, (S103). The call re-sending message includes frequency information which is the information required for the synchronous modem unit (133) of the mobile communication terminal (10) to re-send the packet call to the synchronous mobile communication system (30), and Pseudo Noise (PN) code information of a base station to which hand-over is carried out.

The call re-sending requirement condition in which the asynchronous mobile communication system (20) transmits a call re-sending message to the mobile communication terminal (10) further includes two cases in addition to the afore-mentioned case in which intensity of a pilot signal of the asynchronous mobile communication system (20) in the hand-over area (border area of manganese) is less than a first pre-determined set-up value.

The first case is when intensity of a dummy pilot of the asynchronous mobile communication system (20) existing at a base station of the synchronous mobile communication system (30) available at the asynchronous mobile communication system (20) and the hand-over area rises above a second predetermined value, and the second case is when intensity of a pilot signal is above a third predetermined value as a result of measurement of an intensity of the pilot signal of the synchronous communication system (30) at a hand-over area where the mobile communication terminal (10) can measure a signal intensity of the synchronous mobile communication system (30).

Meanwhile, when the asynchronous modem unit (123) of the mobile communication terminal (10) receives the call re-sending message from the asynchronous mobile communication system (20), the asynchronous modem unit (123) requests the synchronous modem unit (133) of a change to idle mode in response to the control of the common module (140), (S105). The asynchronous modem unit (123) transmits the call re-sending message to the synchronous modem unit (133) to allow using henceforth the message during access attempt with the synchronous mobile communication system (30) as a reference.

The synchronous modem unit (133) is changed to the idle mode in response to the request from the asynchronous modem unit (123), and re-transmits the packet call to the synchronous mobile communication system (30) using the call re-sending message.

Successively, the mobile communication terminal (10) and the synchronous mobile communication system (30) transmit and receive the packet call information to maintain a communicable state.

Although the preferred embodiments of the present invention have been disclosed for illustrative purposes, those skilled in the art will appreciate that various modifications, additions and substitutions are possible, without departing from the scope and spirit of the invention as disclosed in the accompanying claims. Accordingly, the present invention is not limited to the above-described embodiments and the accompanying drawings, but the present invention is defined by the claims.

As apparent from the foregoing, the present invention relates to a mobile communication system capable of packet hand-over between asynchronous network and synchronous network, and more particularly to a mobile communication system and method for packet hand-over between asynchronous communication network and synchronous communication network, and a mobile communication terminal therefor adapted to use a call re-sending message transmitted from asynchronous network and to allow the mobile communication terminal to be connected to the synchronous network, thereby enabling to carry out a packet hand-over between the asynchronous network and the synchronous network.

### INDUSTRIAL APPLICABILITY

The present invention relates to a mobile communication system and method for packet hand-over between asynchronous communication network and synchronous communication network, and mobile communication terminal therefor, and more particularly to a mobile communication system and method for packet hand-over between asynchronous communication network and synchronous communication network, and mobile communication terminal therefor for enabling a mobile phone to be connected to a synchronous communication network using a call re-sending message transmitted in an asynchronous network such that a packet hand-over between asynchronous communication network and synchronous communication network can be performed.

1. A mobile communication terminal which is a multi-mode multi-band mobile communication terminal selectively connected to asynchronous mobile communication system and a synchronous mobile communication system for performing a packet hand-over between asynchronous mobile communication system and the synchronous mobile communication system, wherein the mobile communication terminal comprises:
an asynchronous modem unit receiving a call re-sending message transmitted from the asynchronous mobile communication system when a packet data service of the asynchronous mobile communication system is used; and
a synchronous modem unit changing to an idle state in response to the call re-sending message transmitted from the asynchronous modem unit, and attempting a packet call re-sending with the synchronous mobile communication system in response to synchronous communication system information contained in the call re-sending message.

2. The mobile communication terminal as defined in claim 1, wherein the call re-sending message is generated by the asynchronous mobile communication system in response to intensity information of pilot signal relative to a neighboring base station transmitted from the mobile communication terminal when pilot signal intensity of the asynchronous mobile communication system is less than a first predetermined value at a hand-over area.

3. The mobile communication terminal as defined in claim 1, wherein the call re-sending message is generated by the asynchronous mobile communication system in response to intensity information of pilot signal relative to a neighboring base station transmitted from the mobile communication terminal when intensity of a dummy pilot signal of the asynchronous mobile communication system existing at a base station of the synchronous mobile communication system rises above a second predetermined value.

4. The mobile communication terminal as defined in claim 1, wherein the call re-sending message is generated by the asynchronous mobile communication system in response to intensity information of pilot signal relative to a neighboring base station transmitted from the mobile communication terminal when it is determined that intensity of pilot signal is above a third predetermined value as a result of measurement of pilot signal intensity of the synchronous mobile communication system at a hand-over area where the mobile communication terminal can measure the signal intensity of the synchronous mobile communication system.

5. The mobile communication terminal as defined in claim 1, wherein the call re-sending message includes frequency information and PN code information required when the mobile communication terminal implements a packet call re-sending with the synchronous mobile communication system following implementation of packet hand-over with the mobile communication terminal.

6. A mobile communication system for packet hand-over between asynchronous communication network and synchronous communication network, and the system for implementing a communication with a multi-mode multi-band mobile communication terminal equipped with an asynchronous modem unit and a synchronous modem unit and supporting a packet hand-over between an asynchronous mobile communication system and a synchronous mobile communication system, wherein the asynchronous mobile communication system generates a call re-sending message based on pilot signal intensity information transmitted from the mobile communication terminal and transmits the message to the mobile communication terminal when a call re-sending request condition is met during connection with the mobile communication terminal and transmission and reception of packet data.

7. The mobile communication system for packet hand-over between asynchronous communication network and synchronous communication network as defined in claim 6, wherein the call re-sending message is generated by the asynchronous mobile communication system in response to intensity information of pilot signal relative to a neighboring base station transmitted from the mobile communication terminal when pilot signal intensity of the asynchronous mobile communication system is less than a first predetermined value at a hand-over area.

8. The mobile communication system for packet hand-over between asynchronous communication network and synchronous communication network as defined in claim 6, wherein the call re-sending message is generated by the asynchronous mobile communication system in response to intensity information of pilot signal relative to a neighboring base station transmitted from the mobile communication terminal when intensity of a dummy pilot signal of the asynchronous mobile communication system existing at a base station of the synchronous mobile communication system rises above a second predetermined value.

9. The mobile communication system for packet hand-over between asynchronous communication network and synchronous communication network as defined in claim 6, wherein the call re-sending message is generated by the asynchronous mobile communication system in response to intensity information of pilot signal relative to a neighboring base station transmitted from the mobile communication terminal when it is determined that intensity of pilot signal is above a third predetermined value as a result of measurement of pilot signal intensity of the synchronous mobile communication system at a hand-over area where the mobile communication terminal can measure the signal intensity of the synchronous mobile communication system.

10. The mobile communication system for packet hand-over between asynchronous communication network and synchronous communication network as defined in claim 6, wherein the call re-sending message includes frequency information and PN code information required when the mobile communication terminal implements a packet call re-sending with the synchronous mobile communication system following implementation of packet hand-over with the mobile communication terminal.

11. A mobile communication method for packet hand-over between asynchronous communication network and synchronous communication network, the method comprising the steps of:
providing packet service to a multi-mode multi-band mobile communication terminal by an synchronous mobile communication system;
receiving a pilot signal intensity information transmitted from the mobile communication terminal when a radio communication environment between the asynchronous mobile communication system and the mobile communication terminal meets a call re-sending request condition; and
transmitting to the mobile communication terminal the call re-sending message thus generated to prompt the mobile communication terminal to be connected to the synchronous communication system.

12. The method as defined in claim 11, wherein the call re-sending request condition is a case where pilot signal intensity of the asynchronous mobile communication system is less than a first predetermined value at a hand-over area.

13. The method as defined in claim 11, wherein the call re-sending request condition is a case where intensity of a dummy pilot signal of the asynchronous mobile communication system existing at a base station of the synchronous mobile communication system rises above a second predetermined value.

14. The method as defined in claim 11, wherein the call re-sending request condition is a case where intensity of pilot signal is above a third predetermined value as a result of measurement of pilot signal intensity of the synchronous mobile communication system at a hand-over area where the mobile communication terminal can measure the signal intensity of the synchronous mobile communication system.

15. The method as defined in claim 11, wherein the call re-sending request condition comprises frequency information and PN code information required when the mobile communication terminal implements a packet call re-sending with the synchronous mobile communication system following implementation of packet hand-over with the mobile communication terminal.
